(19) United States
(12) Patent Application Publication
(10) Pub. No.: US 2026/0338669 A1
(43) Pub. Date: Oct. 29, 2026

(54) METHOD AND APPARATUS FOR DETERMINING EFFECTIVENESS OF CATHODIC PROTECTION IN BLIND HORIZONTAL WELL

(71) Applicant: PETROCHINA COMPANY LIMITED, Beijing (CN)

(72) Inventors: Dezhi TANG, Beijing (CN); Dacheng GUO, Beijing (CN); Jie LIU, Beijing (CN); Tan GU, Beijing (CN); Fei ZHAO, Beijing (CN); Min HU, Beijing (CN); Bing LI, Beijing (CN); Xinqiang XIONG, Beijing (CN)

(73) Assignee: PETROCHINA COMPANY LIMITED, Beijing (CN)

(21) Appl. No.: 19/478,013

(22) PCT Filed: Jan. 8, 2024
(86) PCT No.: PCT/CN2024/071188

§ 371 Date: Nov. 13, 2025

(30) Foreign Application Priority Data
Apr. 24, 2023 (CN) 202310447838.4

(51) Int. Cl. G01N 17/00

(52) U.S. Cl. CPC G01N 17/00

(57) ABSTRACT

A method and apparatus for determining the cathodic protection effectiveness of a pipeline at trenchless crossing. The method comprises: according to obtained construction parameters of a pipeline at trenchless crossing to be evaluated, determining a soil resistivity corresponding to the pipeline at trenchless crossing to be evaluated, and corresponding polarization potentials at both ends; from a preconstructed polarization potential threshold table of pipeline at trenchless crossing, obtaining a first polarization potential threshold corresponding to the length and soil resistivity in the construction parameters; and according to the polarization potentials at both ends and the first polarization potential threshold corresponding to the pipeline at trenchless crossing to be evaluated, determining the cathodic protection effectiveness of the pipeline at trenchless crossing to be evaluated. The method and apparatus allow for conveniently and effectively determining the cathodic protection of an entire pipeline at trenchless crossing, further optimizing anti-corrosion measures outside of the pipeline, and significantly improving the safety of pipeline at trenchless crossing.

### FIELD OF THE INVENTION

The present disclosure relates to the technical field of pipeline safety protection, in particular to a method for determining the cathodic protection effectiveness of pipeline at trenchless crossing, a method for constructing a polarization potential threshold table of pipeline at trenchless crossing, an apparatus for determining the cathodic protection effectiveness of pipeline at trenchless crossing, an apparatus for constructing a polarization potential threshold table of pipeline at trenchless crossing, a computer storage medium, a terminal device and a computer program product.

### BACKGROUND OF THE INVENTION

When oil and gas transmission pipelines pass through areas such as rivers, ditches, highways, and railways, directional drilling crossing technology is generally adopted. This is a trenchless construction technology, and the pipeline segment at directional drilling crossing is also called a “pipeline at trenchless crossing”. Since the pipeline at trenchless crossing are deeply buried underground and their upper areas are mostly inaccessible (such as rivers, ditches, highways, and railways), testers cannot reach directly above pipeline at trenchless crossing. This makes it impossible to timely evaluate the external corrosion control effect of pipeline at trenchless crossing and further optimize external anti-corrosion measures, resulting in blind spots and major hidden risks in the external corrosion control management of transmission pipelines. In actual production, problems of external corrosion failure of pipeline at trenchless crossing have occurred many times, causing huge economic losses and at the same time bringing severe impacts on production.

In actual production, both external anti-corrosion coatings and cathodic protection are usually adopted to protect pipeline at trenchless crossing. Due to the characteristics of directional drilling construction technology and environmental conditions, the integrity of the external anti-corrosion coating of the pipeline at trenchless crossing often cannot be guaranteed. Therefore, it is more necessary to ensure the effectiveness of cathodic protection. Existing technologies determine whether the cathodic protection of the entire pipeline segment meets the standards by testing the cathodic protection potentials at both ends of the pipeline at trenchless crossing on the ground surface. However, in practice, the burial depth of pipeline at trenchless crossing ranges from several meters to dozens of meters, and the length of the crossing segment may reach several kilometers. As a result, there are significant differences between the external corrosion environment at the ground surface of the two ends of the pipeline at trenchless crossing and that at its deepest part. This leads to obvious differences in polarization characteristics between the two ends and the deepest part of pipeline at trenchless crossing, as well as great differences in cathodic protection effect. Therefore, the cathodic protection potentials at the two ends of pipeline at trenchless crossing cannot reflect the cathodic protection effect of the entire pipeline at trenchless crossing. Consequently, there is an urgent need for a simple, convenient, scientific and effective method for determining the cathodic protection effectiveness of pipeline at trenchless crossing. At the same time, there is an urgent need for a strategy to optimize the cathodic protection system, so as to effectively control the risk of external corrosion perforation of pipeline at trenchless crossing, improve the intrinsic safety level of pipeline at trenchless crossing and contribute to quality improvement and efficiency enhancement.

### SUMMARY OF THE INVENTION

In the prior art, the cathodic protection potentials measured at the ground surface of both ends of a pipeline at trenchless crossing cannot reflect the cathodic protection effect of the entire pipeline at trenchless crossing. To expand the range of options, the embodiments of the present disclosure provide a method and apparatus for determining the cathodic protection effectiveness of pipeline at trenchless crossing.

In a first aspect, the embodiments of the disclosure provide a method for determining the cathodic protection effectiveness of pipeline at trenchless crossing, including: obtaining construction parameters of the pipeline at trenchless crossing to be evaluated, according to the construction parameters, determining a soil resistivity corresponding to the pipeline at trenchless crossing to be evaluated, and corresponding polarization potentials at both ends;

from a preconstructed a polarization potential threshold table of pipeline at trenchless crossing, obtaining a first polarization potential threshold corresponding to a length and the soil resistivity in the construction parameters, wherein the polarization potential threshold table of the pipeline at trenchless crossing includes the length of entire pipeline at trenchless crossing, the soil resistivity corresponding to the pipeline at trenchless crossing, and the first polarization potential threshold, and the polarization potential threshold table of pipeline at trenchless crossing represents the corresponding relationship among the length, the soil resistivity, and the polarization potential threshold of the pipeline at trenchless crossing; and according to the polarization potentials at both ends and first polarization potential threshold corresponding to the pipeline at trenchless crossing to be evaluated, determining the cathodic protection effectiveness of the pipeline at trenchless crossing to be evaluated.

In one embodiment, determining the soil resistivity corresponding to the pipeline at trenchless crossing to be evaluated includes:

adopting the following formula to determine a spacing between two adjacent probes during testing:

αᵢ=INT(h~H);
in the above formula, h represents the buried depth at both ends of the pipeline at trenchless crossing, H represents the maximum buried depth of the pipeline at trenchless crossing, and INT represents an integer function;
adopting the following formula to obtain the soil resistivity corresponding to the pipeline at trenchless crossing:

$$ρ = {max}_{h \leq i \leq H} ( 2 π {a}_{i} {R}_{i} ) ;$$

in the above formula, h represents the buried depth at both ends of the pipeline at trenchless crossing, H represents the maximum buried depth of the pipeline at trenchless crossing, aᵢ represents the spacing between two adjacent probes during testing, and Rᵢ represents a resistance value of the soil near the pipeline at trenchless crossing when the spacing between two adjacent probes is aᵢ.

In one embodiment, from the preconstructed polarization potential threshold table of the pipeline at trenchless crossing, obtaining the first polarization potential threshold corresponding to the length and soil resistivity in the construction parameters further includes:
if the soil resistivity corresponding to the pipeline at trenchless crossing to be evaluated is within a preset soil resistivity range, then according to the length of the pipeline at trenchless crossing to be evaluated and two end values of the preset soil resistivity range, matching a second polarization potential threshold and a third polarization potential threshold corresponding to the length of the pipeline at trenchless crossing to be evaluated and the two end values in the polarization potential threshold table of pipeline at trenchless crossing;
adopting the following formula to calculate the first polarization potential threshold corresponding to the pipeline at trenchless crossing to be evaluated:

(ρ−ρ₁)/(ρ₂−ρ)=(Eₘₐₓ−E₁)/(E₂−Eₘₐₓ);
in the above formula, Eₘₐₓ represents the first polarization potential threshold, ρ represents the soil resistivity corresponding to the pipeline at trenchless crossing, ρ₁ and ρ₂ represent the two end values of the preset soil resistivity range, E₁ represents the second polarization potential threshold, and E₂ represents the third polarization potential threshold;
if the soil resistivity corresponding to the pipeline at trenchless crossing to be evaluated is not within the preset soil resistivity range, then according to the length of the entire pipeline at trenchless crossing to be evaluated and the soil resistivity, matching a first polarization potential threshold corresponding to the length and the soil resistivity of the pipeline at trenchless crossing to be evaluated in the polarization potential threshold table of the pipeline at trenchless crossing.

In one embodiment, according to the polarization potentials at both ends and the first polarization potential threshold corresponding to the pipeline at trenchless crossing to be evaluated, determining the cathodic protection effectiveness of pipeline at trenchless crossing to be evaluated includes:
judging whether the polarization potentials at both ends corresponding to the pipeline at trenchless crossing to be evaluated are both less than the first polarization potential threshold, if yes, determining that the cathodic protection for the pipeline at trenchless crossing to be evaluated is effective; if not, determining that the cathodic protection for the pipeline at trenchless crossing to be evaluated is ineffective.

In a second aspect, the embodiments of the disclosure provide a method for constructing a polarization potential threshold table of pipeline at trenchless crossing, including:
obtaining construction parameters and soil environment parameters of a pipeline at trenchless crossing;
calculating a soil resistivity corresponding to the pipeline at trenchless crossing according to the construction parameters;
according to the construction parameters and the soil environment parameters, adopting a method of numerical simulation to construct a threshold model of polarization potentials at both ends of the pipeline at trenchless crossing; calculating polarization potential thresholds corresponding to the pipeline at trenchless crossing under different types of external anti-corrosion coatings and different soil resistivities using the threshold model of polarization potentials at both ends of the pipeline at trenchless crossing; and
constructing a polarization potential threshold table of the pipeline at trenchless crossing according to the length in the construction parameters of the pipeline at trenchless crossing, the soil resistivity corresponding to the pipeline at trenchless crossing, and the polarization potential thresholds corresponding to the pipeline at trenchless crossing.

In a third aspect, the embodiments of the disclosure provide an apparatus for determining the cathodic protection effectiveness of the pipeline at trenchless crossing, including:
a first determining module, configured to obtain construction parameters of a pipeline at trenchless crossing to be evaluated, according to the construction parameters, determine a soil resistivity corresponding to the pipeline at trenchless crossing to be evaluated, and corresponding polarization potentials at both ends;
an obtaining module, configured to, from a preconstructed polarization potential threshold table of pipeline at trenchless crossing, obtain a first polarization potential threshold corresponding to a length and the soil resistivity in the construction parameters, wherein the polarization potential threshold table of pipeline at trenchless crossing includes the length of the pipeline at trenchless crossing, the soil resistivity corresponding to the pipeline at trenchless crossing, and the first polarization potential threshold, and the polarization potential threshold table of pipeline at trenchless crossing represents the corresponding relationship among the length, the soil resistivity, and the polarization potential threshold of the pipeline at trenchless crossing; and
a second determining module, configured to, according to the polarization potentials at both ends and first polarization potential threshold corresponding to the pipeline at trenchless crossing to be evaluated, determine the cathodic protection effectiveness of the pipeline at trenchless crossing to be evaluated.

In a fourth aspect, the embodiments of the disclosure provide an apparatus for constructing a polarization potential threshold table of pipeline at trenchless crossing, including:
an obtaining module, configured to obtain construction parameters and soil environment parameters of a pipeline at trenchless crossing;
a first calculation module, configured to calculate a soil resistivity corresponding to the pipeline at trenchless crossing according to the construction parameters;
a second calculation module, configured to, according to the construction parameters and the soil environment parameters, adopt a method of numerical simulation to construct a threshold model of polarization potentials at both ends of the pipeline at trenchless crossing; calculate polarization potential thresholds corresponding to the pipeline at trenchless crossing under different types of external anti-corrosion coatings and different soil resistivities using the threshold model of polarization potentials at both ends of the pipeline at trenchless crossing; and
a construction module, configured to construct a polarization potential threshold table of pipeline at trenchless crossing according to the length in the construction parameters of the pipeline at trenchless crossing, the soil resistivity corresponding to the pipeline at trenchless crossing, and the polarization potential thresholds corresponding to the pipeline at trenchless crossing.

In a fifth aspect, the embodiments of the present disclosure provide a computer storage medium, wherein the computer storage medium has stored thereon computer-executable instructions that, when executed by a processor, implement the method for determining the cathodic protection effectiveness of pipeline at trenchless crossing or the method for constructing a polarization potential threshold table of pipeline at trenchless crossing.

In a sixth aspect, the embodiments of the present disclosure provide a terminal device, including a memory, a processor and a computer program stored on the memory and executable on the processor, the program, when executed by the processor, implementing the method for determining the cathodic protection effectiveness of pipeline at trenchless crossing or the method for constructing a polarization potential threshold table of pipeline at trenchless crossing.

In a seventh aspect, the embodiments of the disclosure provide a computer program product, including a computer program which, when executed by a processor, implements the method for determining the cathodic protection effectiveness of pipeline at trenchless crossing or the method for constructing a polarization potential threshold table of pipeline at trenchless crossing.

The beneficial effects of the above technical solutions provided by the embodiments of the present disclosure include at least:
the embodiments of the present disclosure provide a method for determining the cathodic protection effectiveness of pipeline at trenchless crossing, and the method includes: obtaining construction parameters of a pipeline at trenchless crossing to be evaluated, according to the construction parameters of the pipeline at trenchless crossing to be evaluated, determining a soil resistivity corresponding to the pipeline at trenchless crossing to be evaluated, and corresponding polarization potentials at both ends, matching a polarization potential threshold corresponding to the length of the entire pipeline at trenchless crossing to be evaluated and the soil resistivity of the pipeline at trenchless crossing to be evaluated in the preconstructed polarization potential threshold table, and according to the polarization potentials at both ends corresponding to the pipeline at trenchless crossing to be evaluated and the polarization potential threshold, evaluating the cathodic protection effectiveness of the pipeline at trenchless crossing to be evaluated. This method enables convenient, scientific, and accurate determination of whether the cathodic protection for the pipeline at trenchless crossing to be evaluated is effective, improves the accuracy of judging whether the cathodic protection effectiveness of the pipeline at trenchless crossing meets the standards, facilitates the timely implementation of measures to enhance the cathodic protection for the pipeline at trenchless crossing to be evaluated when the effectiveness fails to meet the standards, and reduces the risk of external corrosion perforation of the pipeline at trenchless crossing to be evaluated.

The embodiments of the present disclosure provide a method for constructing a polarization potential threshold table of pipeline at trenchless crossing, the method includes: obtaining construction parameters and soil environment parameters of a pipeline at trenchless crossing; calculating a soil resistivity corresponding to the pipeline at trenchless crossing according to the obtained construction parameters; according to the construction parameters and the soil environment parameters of the pipeline at trenchless crossing, constructing a threshold model of polarization potentials at both ends of the pipeline at trenchless crossing; calculating polarization potential thresholds of the pipeline at trenchless crossing using the threshold model of polarization potentials at both ends; and constructing a polarization potential threshold table according to the length in the construction parameters of the pipeline at trenchless crossing, the soil resistivity corresponding to the pipeline at trenchless crossing, and the polarization potential thresholds corresponding to the pipeline at trenchless crossing. The polarization potential threshold table represents the corresponding relationship among the length, the soil resistivity, and the polarization potential threshold of the pipeline at trenchless crossing. The use of the polarization potential threshold table provides sound data support for the cathodic protection effectiveness evaluation of the pipeline at trenchless crossing.

Additional features and advantages of the disclosure will be set forth in the description which follows, and in part will be obvious from the description, or may be learned by practice of the disclosure. The objectives and other advantages of the disclosure will be realized and attained by the structure particularly pointed out in the written description and claims hereof as well as the appended drawings.

The technical solution of the present disclosure is further described in detail below by the accompanying drawings and embodiments.

### BRIEF DESCRIPTION OF DRAWINGS

The accompanying drawings are intended to provide a further understanding of the embodiments of the present disclosure, and form a part of the description, and together with the following Detailed Description, serve to explain the embodiments of the present disclosure, but are not intended to be limiting thereon. In the drawings:

FIG. 1 is a flow chart illustrating a method for determining the cathodic protection effectiveness of pipeline at trenchless crossing in accordance with an embodiment of the present disclosure;

FIG. 2 is a flow chart illustrating a method of constructing a polarization potential threshold table of pipeline at trenchless crossing in accordance with an embodiment of the present disclosure;

FIG. 3 is a flow chart illustrating a method for optimizing cathodic protection in a pipeline at trenchless crossing in accordance with an embodiment of the present disclosure;

FIG. 4 is a structural schematic diagram of an apparatus for determining the cathodic protection effectiveness of pipeline at trenchless crossing in accordance with an embodiment of the present disclosure; and

FIG. 5 is a structural schematic diagram of an apparatus for constructing a polarization potential threshold table of pipeline at trenchless crossing in accordance with an embodiment of the present disclosure.

### DETAILED DESCRIPTION OF THE EMBODIMENTS

Exemplary embodiments of the present disclosure will be described in more detail below with reference to the accompanying drawings. While exemplary embodiments of the present disclosure are illustrated in the accompanying drawings, it should be understood that the present disclosure may be embodied in various forms and should not be limited to the embodiments set forth herein. Rather, these embodiments are provided so that this disclosure will be more thorough, and will fully convey the scope of the disclosure to those skilled in the art.

The inventor found in their work that, in the prior art, testing the cathodic protection potentials at both ends of the pipeline at trenchless crossing cannot accurately reflect the cathodic protection effect of the entire pipeline at trenchless crossing. After further research and development, the inventor completed the present disclosure. The embodiments of the present disclosure provide a method for determining the cathodic protection effectiveness of pipeline at trenchless crossing, as well as a method and apparatus for constructing a polarization potential threshold table of pipeline at trenchless crossing.

### EMBODIMENTS

A method for determining the cathodic protection effectiveness of a pipeline at trenchless crossing is described in detail below with reference to the embodiments.

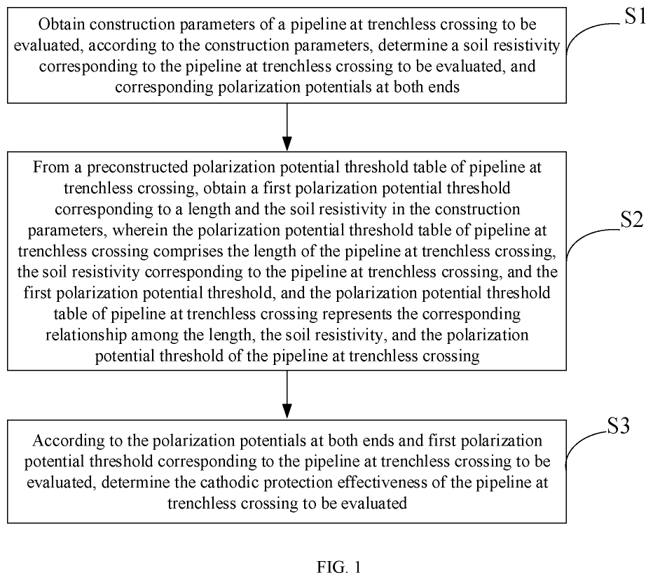

Embodiments of the present disclosure provide a method for determining the cathodic protection effectiveness of pipeline at trenchless crossing, the process of which is illustrated in FIG. 1, including the steps of:
Step S1: construction parameters of a pipeline at trenchless crossing to be evaluated are obtained, according to the construction parameters, a soil resistivity corresponding to the pipeline at trenchless crossing to be evaluated, and corresponding polarization potentials at both ends are determined;
Step S2: from a preconstructed polarization potential threshold table of pipeline at trenchless crossing, a first polarization potential threshold corresponding to a length and the soil resistivity in the construction parameters is obtained, wherein the polarization potential threshold table includes the length of the entire pipeline at trenchless crossing, the soil resistivity and the first polarization potential threshold corresponding to the pipeline at trenchless crossing, and the polarization potential threshold table represents the corresponding relationship among the length, the soil resistivity, and the polarization potential threshold of the pipeline at trenchless crossing;
Step S3: according to the polarization potentials at both ends and first polarization potential threshold corresponding to the pipeline at trenchless crossing to be evaluated, the cathodic protection effectiveness of the pipeline at trenchless crossing to be evaluated is determined.

To distinguish the polarization potential threshold corresponding to the pipeline at trenchless crossing to be evaluated from those corresponding to other pipeline at trenchless crossings, in the following description, the polarization potential threshold corresponding to the pipeline at trenchless crossing to be evaluated is referred to as the first polarization potential threshold.

There are many construction parameters for the pipeline at trenchless crossing, in an embodiment of the disclosure, the acquired construction parameters are, for example, the length L of the entire pipeline at trenchless crossing, the maximum buried depth H of the pipeline at trenchless crossing, the buried depth h at both ends of the pipeline at trenchless crossing, the type of cathodic protection of the pipeline at trenchless crossing, and the like. It should be noted that the buried depth error at both ends of the pipeline at trenchless crossing is generally less than a preset error threshold, for example, a preset error threshold value of 5 meters, so that the buried depth at both ends of the pipeline at trenchless crossing can be considered to be uniform. Other construction parameters of the pipeline at trenchless crossing, such as the type of its anti-corrosion coating, can also be obtained based on actual calculation requirements, and the embodiments of the present disclosure do not impose restrictions on this.

In some optional embodiments, the Wenner four-electrode method can be used to test the soil resistivity corresponding to the pipeline at trenchless crossing. The above Step S1 that the soil resistivity corresponding to the pipeline at trenchless crossing to be evaluated is determined can be implemented in the following manner:
I. The following formula is adopted to determine a spacing between two adjacent probes during testing:

αᵢ=INT(h~H); (1)
in the above formula, h represents the buried depth at both ends of the pipeline at trenchless crossing, H represents the maximum buried depth of the pipeline at trenchless crossing, and INT represents an integer function;
αᵢ represents the spacing between two adjacent probes during on-site testing using the Wenner four-electrode method. During calculation, the value range of di is integers between h and H (inclusive). In actual calculations, values can be determined in the following manner: integers from h to H (including both h and H) are selected. If the maximum burial depth H of the pipeline at trenchless crossing to be evaluated is relatively large, some integers from h to H (including both h and H) can also be selected to assign values to αᵢ. For example, if h is 2 meters and H is 15 meters, the spacing αᵢ between two adjacent probes are 2 m, 3 m, 4 m, 5 m, 6 m . . . 15 m respectively. Another example: if h is 2 meters and H is 100 meters, the spacing αᵢ between two adjacent probes are 2 m, 3 m, 4 m, 10 m, 20 m, 30 m . . . 70 m, 80 m, 90 m, 95 m, 96 m, 97 m, 98 m, 99 m, 100 m respectively.

II. The following formula is adopted to obtain the soil resistivity corresponding to the pipeline at trenchless crossing:

$$ρ = {max}_{h \leq i \leq H} ( 2 π {a}_{i} {R}_{i} ) ; \qquad ( 2 )$$

in the above formula, h represents the buried depth at both ends of the pipeline at trenchless crossing, H represents the maximum buried depth of the pipeline at trenchless crossing, aᵢ represents the spacing between two adjacent probes during testing, Rᵢ represents a resistance value of the soil near the pipeline at trenchless crossing when the spacing between two adjacent probes is aᵢ, and max represents a maximum function.

In some optional embodiments, the above Step S1 that polarization potentials at both ends corresponding to the pipeline at trenchless crossing to be evaluated are determined can be implemented in the following manner:

I. If the pipeline at trenchless crossing to be evaluated adopts impressed current cathodic protection type, a multimeter and a reference electrode shall be used to test the polarization potentials at both ends of the pipeline at trenchless crossing to be evaluated through the instant power-off potential method.

The multimeter is used, the positive terminal of the multimeter is connected to the pipeline at trenchless crossing to be evaluated, and the negative terminal is connected to a copper sulfate reference electrode (CSE). By instantly disconnecting the power supply of the impressed current cathodic protection system, the polarization potentials E1 and E2 at both ends of the pipeline at trenchless crossing to be evaluated are tested respectively. The test results obtained with the copper sulfate reference electrode are more stable than those with other reference electrodes. Of course, a high-purity zinc reference electrode, a silver chloride reference electrode, or a calomel reference electrode can also be used, and the embodiments of the present disclosure do not impose restrictions on this.

II. If the pipeline at trenchless crossing to be evaluated adopts at least a galvanic anode as the cathodic protection type, a multimeter and a polarization probe shall be used to test the polarization potentials at both ends of the pipeline at trenchless crossing to be evaluated through the polarization probe method. The polarization probe includes a copper sulfate reference electrode and a metal sheet, and the metal sheet is connected to the pipeline at trenchless crossing to be evaluated.

When the pipeline at trenchless crossing to be evaluated adopts at least a galvanic anode as the cathodic protection type, there are two cases: the first is that the pipeline at trenchless crossing to be evaluated adopts a galvanic anode as the cathodic protection type; the second is that it adopts a combined cathodic protection type of galvanic anode and impressed current. In these two cases, the cathodic protection polarization potential cannot be accurately tested by the instant power-off potential method, so the polarization probe method is selected. The specific operation is: the positive terminal of the multimeter is connected to the metal sheet of the polarization probe, and the negative terminal is connected to the copper sulfate reference electrode of the polarization probe. By instantly disconnecting the connection between the metal sheet and the pipeline at trenchless crossing to be evaluated, the polarization potentials E1 and E2 at both ends of the pipeline at trenchless crossing to be evaluated are tested respectively. It should be noted that when testing with the polarization probe method, the burial depth of the polarization probe is the same as that at both ends of the pipeline at trenchless crossing to be evaluated.

In some optional embodiments, the above Step S2 involves that, from a preconstructed polarization potential threshold table of pipeline at trenchless crossing, a first polarization potential threshold corresponding to a length and the soil resistivity in the construction parameters is obtained, if the soil resistivity corresponding to the pipeline at trenchless crossing to be evaluated is not within the preset soil resistivity range, then according to the length and the soil resistivity of the pipeline at trenchless crossing to be evaluated, a first polarization potential threshold corresponding to the length and the soil resistivity of the pipeline at trenchless crossing to be evaluated is matched from the polarization potential threshold table. For example, as shown in the polarization potential threshold table below, when the length L of the entire pipeline at trenchless crossing to be evaluated is 300 m, the soil resistivity ρ of the pipeline at trenchless crossing to be evaluated is 50 Ω-m as tested, and the polarization potential threshold of the pipeline at trenchless crossing to be evaluated is −1100 mV as matched from the polarization potential threshold table.

The polarization potential threshold table of pipeline at trenchless crossing is shown in Table 1 below:

TABLE 1

| | Length | Nearby | Maximum value of |
|---|---|---|---|
| | of pipeline | soil | polarization potentials at |
| Serial | at trenchless | resistivity | both ends of pipeline at |
| number | crossing L/m | ρ/Ω · m | trenchless crossing, Eₘₐₓ/mV |
| 1 | <500 | <25 | −950 |
| 2 | | 25 | −960 |
| 3 | | 50 | −1100 |
| 4 | | ≥100 | −1170 |
| 5 | 500 | ≤25 | −960 |
| 6 | | 50 | −1100 |
| 7 | | ≥100 | −1170 |
| 8 | 500 < L ≤ 1000 | ≤25 | −970 |
| 9 | | 50 | −1100 |
| 10 | | ≥100 | −1170 |
| 11 | 1000 < L ≤ 2000 | ≤25 | −1000 |
| 12 | | 50 | −1100 |
| 13 | | ≥100 | −1170 |
| 10 | 2000 < L ≤ 5000 | ≤25 | −1050 |
| 11 | | 50 | −1100 |
| 12 | | ≥100 | −1170 |

if ρ≤25 Ω-m or ρ=50 Ω-m or ρ≥100 Ω-m, the first polarization potential threshold can be obtained by directly looking up the polarization potential threshold table of pipeline at trenchless crossing;
if 25 Ω-m<ρ<50 Ω-m or 50 Ω-m<ρ<100 Ω-m, if the corresponding first polarization potential threshold cannot be directly matched from the polarization potential threshold table, the interpolation method shall be used to calculate and obtain the first polarization potential threshold.

In some optional embodiments, the above Step S2 that, from the preconstructed polarization potential threshold table, the first polarization potential threshold corresponding to the length and soil resistivity in the construction parameters is obtained can be implemented in the following manner:
if the soil resistivity corresponding to the pipeline at trenchless crossing to be evaluated is within a preset soil resistivity range, then according to the length of the entire pipeline at trenchless crossing to be evaluated and two end values of the preset soil resistivity range, a second polarization potential threshold and a third polarization potential threshold corresponding to the length of the entire pipeline at trenchless crossing to be evaluated and the two end values are matched from the polarization potential threshold table;
the following formula is adopted to calculate the first polarization potential threshold corresponding to the pipeline at trenchless crossing to be evaluated:

(ρ−ρ1)/(ρ2−ρ)=(Eₘₐₓ−E₁)/(E₂−Eₘₐₓ); (3)
in the above formula, Eₘₐₓ represents the first polarization potential threshold, ρ represents the soil resistivity corresponding to the pipeline at trenchless crossing, ρ₁ and ρ₂ represent the two end values of the preset soil resistivity range, E₁ represents the second polarization potential threshold, and E₂ represents the third polarization potential threshold.

For example, if the length L of the pipeline at trenchless crossing to be evaluated is 300 m, and the tested soil resistivity ρ of the pipeline at trenchless crossing to be evaluated is 700 Ω·m, β₁ is obtained as 50 Ω·m and ρ₂ as 100 Ω·m from the polarization potential threshold table of pipeline at trenchless crossing. The second polarization potential threshold corresponding to ρ₁ is −1100 mV, and the third polarization potential threshold corresponding to ρ₂ is −1170 mV. ρ₁, ρ₂, E₁ and E₂ are substituted into Formula (3):

(70−50)/(100−70)−(Eₘₐₓ−(−1100))/(−1170−Eₘₐₓ);

Eₘₐₓ=−1128 mV is obtained by solving.

In some optional embodiments, the above Step S3 that, according to the polarization potentials at both ends and the first polarization potential threshold corresponding to the pipeline at trenchless crossing to be evaluated, the cathodic protection effectiveness of the pipeline at trenchless crossing to be evaluated is determined can be implemented in the following manner:
whether the polarization potentials at both ends corresponding to the pipeline at trenchless crossing to be evaluated are both less than the first polarization potential threshold is judged, if yes, it is determined that the cathodic protection for the pipeline at trenchless crossing to be evaluated is effective; if not, it is determined that the cathodic protection for the pipeline at trenchless crossing to be evaluated is ineffective.

The method for constructing a polarization potential threshold table of pipeline at trenchless crossing is described in detail below with reference to embodiments.

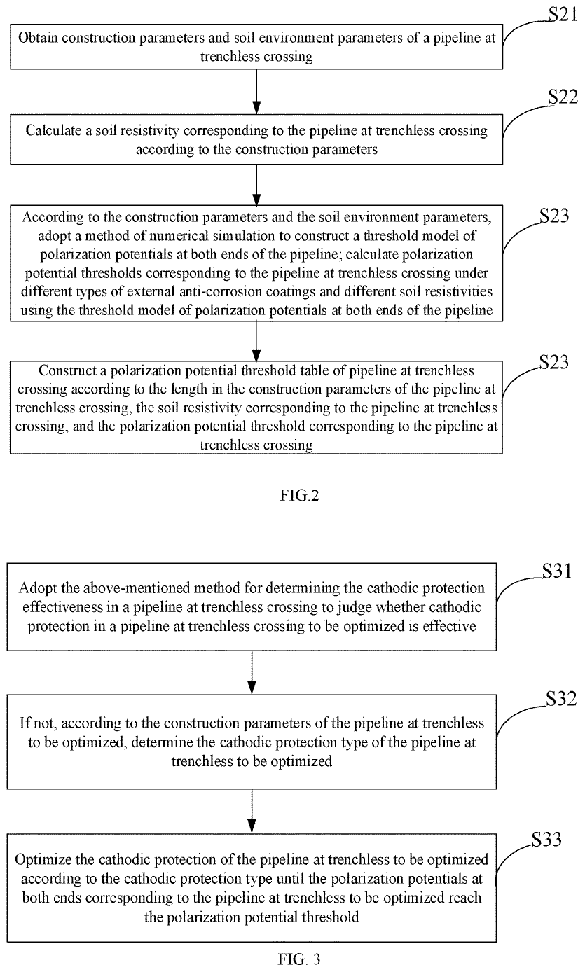

The embodiment of the present disclosure provides a method for constructing a polarization potential threshold table of pipeline at trenchless crossing, the flow of which is shown in FIG. 2, including the following steps:
Step S21: construction parameters and soil environment parameters of a pipeline at trenchless crossing are obtained;
Step S22: a soil resistivity corresponding to the pipeline at trenchless crossing is calculated according to the construction parameters;
Step S23: according to the construction parameters and the soil environment parameters, a method of numerical simulation is adopted to construct a threshold model of polarization potentials at both ends of the pipeline; polarization potential thresholds corresponding to the pipeline at trenchless crossing under different types of external anti-corrosion coatings and different soil resistivities are calculated using the threshold model of polarization potentials at both ends of the pipeline; and
Step S24: a polarization potential threshold table of pipeline at trenchless crossing is constructed according to the length in the construction parameters of the pipeline at trenchless crossing, the soil resistivity corresponding to the pipeline at trenchless crossing, and the polarization potential threshold corresponding to the pipeline at trenchless crossing.

In some optional embodiments, for the Step S23 mentioned above, numerical simulation software (BEASY) may be used to construct the threshold model of polarization potentials at both ends of the pipeline. By applying different types of external anti-corrosion coatings to the pipeline at trenchless crossing and changing the soil boundary around the pipeline at trenchless crossing, the polarization potential thresholds corresponding to the pipeline at trenchless crossing under different external anti-corrosion coating types and different soil resistivities are calculated.

To improve the accuracy of the polarization potential threshold corresponding to the pipeline at trenchless crossing, the relevant data of the pipeline at trenchless crossing obtained from on-site testing can also be combined to correct the calculated polarization potential threshold corresponding to the pipeline at trenchless crossing, so as to reduce the error of the polarization potential threshold corresponding to the pipeline at trenchless crossing.

With reference to the polarization potential threshold table mentioned above, the constructed polarization potential threshold table of pipeline at trenchless crossing is obtained.

Based on the method for determining the cathodic protection effectiveness of pipeline at trenchless crossing and the method for constructing a polarization potential threshold table of pipeline at trenchless crossing provided in the embodiments of the present disclosure, optimization treatment can be performed on the pipeline at trenchless crossing whose cathodic protection effectiveness fails to meet the standard. With reference to FIG. 3, for example, this can be achieved through the following steps:
Step S31: the above-mentioned method for determining the cathodic protection effectiveness of pipeline at trenchless crossing is adopted to judge whether cathodic protection in a pipeline at trenchless crossing to be optimized is effective;
Step S32: if not, according to the construction parameters of the pipeline at trenchless crossing to be optimized, the cathodic protection type of the pipeline at trenchless crossing to be optimized is determined;
Step S33: the cathodic protection of the pipeline at trenchless crossing to be optimized is optimized according to the cathodic protection type until the polarization potentials at both ends corresponding to the pipeline at trenchless crossing to be optimized reach the polarization potential threshold.

In some optional embodiments, the above Step S33 may be implemented as follows:

I. If the pipeline at trenchless crossing to be optimized adopts at least impressed current as the cathodic protection type, the cathodic protection of the pipeline at trenchless crossing to be optimized shall be optimized by adjusting the output parameters of the potentiostat. If the pipeline at trenchless crossing to be optimized adopts impressed current cathodic protection or combined impressed current and galvanic anode cathodic protection, the output parameters of the potentiostat in the impressed current cathodic protection system can be increased step by step. The specific operation is as follows: when the potentiostat operates in a potentiostatic mode, the control potential is gradually adjusted to be more negative (e.g., adjust from −1200 mV to −1250 mV, −1300 mV, −1350 mV, −1400 mV) until the polarization potentials E1 and E2 at both ends of the pipeline at trenchless crossing to be optimized both reach the corresponding polarization potential threshold. When the potentiostat operates in a galvanostatic mode, the output current value is gradually increased (e.g., adjust from 1.0 A to −1.1 A, −1.2 A, −1.3 A, −1.4 A) until the polarization potentials E1 and E2 at both ends of the pipeline at trenchless crossing to be optimized both reach the corresponding polarization potential threshold.

II. If the pipeline at trenchless crossing to be optimized adopts the galvanic anode cathodic protection type, the cathodic protection of the pipeline at trenchless crossing to be optimized shall be optimized by adjusting the number of galvanic anodes.

If the pipeline at trenchless crossing to be optimized adopts the galvanic anode cathodic protection type, the cathodic protection effect can be optimized by increasing the number of galvanic anodes added at both ends of the pipeline at trenchless crossing, until the polarization potentials E1 and E2 at both ends to be optimized both reach the corresponding polarization potential threshold.

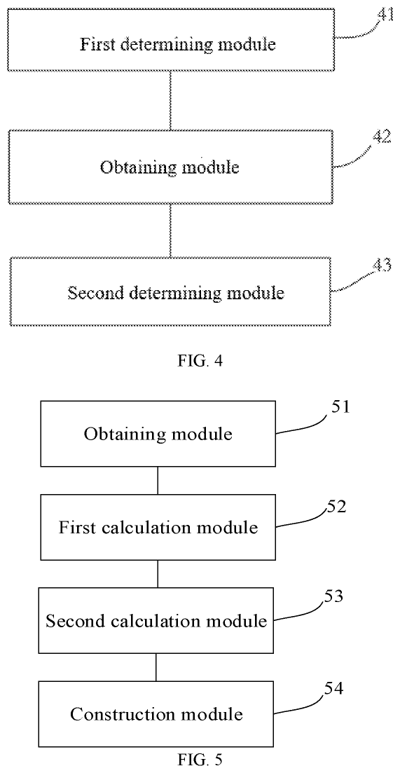

On the basis of the same inventive concept, the embodiments of the present disclosure also provide an apparatus for determining the cathodic protection effectiveness of pipeline at trenchless crossing, the structure of which is shown in FIG. 4, including:
a first determining module 41, configured to obtain construction parameters of a pipeline at trenchless crossing to be evaluated, according to the construction parameters, determine a soil resistivity corresponding to the pipeline at trenchless crossing to be evaluated, and corresponding polarization potentials at both ends;
an obtaining module 42, configured to, from a preconstructed polarization potential threshold table of pipeline at trenchless crossing, obtain a first polarization potential threshold corresponding to a length and the soil resistivity in the construction parameters, wherein the polarization potential threshold table includes the length of the entire pipeline at trenchless crossing, the soil resistivity corresponding to the pipeline at trenchless crossing, and the first polarization potential threshold, and the polarization potential threshold table represents the corresponding relationship among the length, the soil resistivity, and the polarization potential threshold of the pipeline at trenchless crossing; and
a second determining module 43, configured to, according to the polarization potentials at both ends and first polarization potential threshold corresponding to the pipeline at trenchless crossing to be evaluated, determine the cathodic protection effectiveness of of the pipeline at trenchless crossing to be evaluated.

With respect to the apparatus for determining the cathodic protection effectiveness of a pipeline at trenchless crossing in the above-described embodiment, the specific manner in which the various modules perform the operations has been described in detail in relation to the embodiment of the method and will not be described in detail herein.

Based on the same inventive concept, the embodiments of the present disclosure also provide an apparatus for constructing a polarization potential threshold table of pipeline at trenchless crossing, the apparatus having a structure as shown in FIG. 5, including:
an obtaining module 51, configured to obtain construction parameters and soil environment parameters of a pipeline at trenchless crossing;
a first calculation module 52, configured to calculate a soil resistivity corresponding to the pipeline at trenchless crossing according to the construction parameters;
a second calculation module 53, configured to, according to the construction parameters and the soil environment parameters, adopt a method of numerical simulation to construct a threshold model of polarization potentials at both ends of the pipeline; calculate polarization potential thresholds corresponding to the pipeline at trenchless crossing under different types of external anti-corrosion coatings and different soil resistivities using the threshold model of polarization potentials at both ends of the pipeline; and
a construction module 54, configured to construct a polarization potential threshold table according to the length in the construction parameters of the pipeline at trenchless crossing, the soil resistivity corresponding to the pipeline at trenchless crossing, and the polarization potential threshold corresponding to the pipeline at trenchless crossing.

Regarding the apparatus for constructing a pipeline at trenchless crossing polarization potential threshold table in the above embodiment, the specific manner in which the various modules perform the operations has been described in detail in relation to the embodiment of the method and will not be described in detail here.

Based on the same inventive concept, the embodiments of the present disclosure also provide a computer storage medium having stored thereon computer-executable instructions that, when executed by a processor, implement the above-described method for determining the cathodic protection effectiveness of a pipeline at trenchless crossing or the above-described method for constructing a polarization potential threshold table of pipeline at trenchless crossing.

Based on the same inventive concept, the embodiments of the present disclosure further provide a terminal device, including: a memory, a processor, and a computer program stored on the memory and executable on the processor, the program, when executed by the processor, implementing the above-described method for determining the cathodic protection effectiveness of a pipeline at trenchless crossing or the above-described method for constructing a polarization potential threshold table of pipeline at trenchless crossing.

Based on the same inventive concept, the embodiments of the present disclosure also provide a computer program product, characterized in that the computer program product includes a computer program which, when executed by a processor, implements the above-described method for determining the cathodic protection effectiveness of a pipeline at trenchless crossing or the above-described method for constructing a polarization potential threshold table of pipeline at trenchless crossing.

The disclosure is illustrated with a specific embodiment:
1. By consulting the construction data of the pipeline at trenchless crossing, the following information is obtained: the length L of the entire pipeline at trenchless crossing is 1000 m, the maximum burial depth H of the pipeline at trenchless crossing is 15 m, the burial depth h at both ends of the pipeline at trenchless crossing is 2 m, and the entire pipeline adopts the impressed current cathodic protection type;
2. The Wenner four-electrode method is used to test the soil resistivity ρ near the pipeline at trenchless crossing. The spacing aᵢ between two adjacent probes is set to be 2 m, 3 m, 4 m, 5 m, 6 m . . . 15 m in sequence, and the corresponding measured resistance values Ri are 16Ω, 0.9Ω, 0.865Ω, 0.860, 0.845Ω, 0.835Ω, 0.835Ω, 0.825Ω, 0.81Ω, 0.800, 0.79Ω, 0.77Ω, 0.76Ω, 0.750Ω, respectively;
3. By solving Formula (2), the result is obtained as follows:

$$ρ = {max}_{2 \leq i \leq 15} ( 2 π {a}_{i} {R}_{i} ) = 70 Ω \cdot m ;$$

4. Since the pipeline at trenchless crossing adopts the impressed current cathodic protection type, it is determined that the instant power-off potential method is used to test the polarization potentials at both ends of the pipeline at trenchless crossing;
5. Using a copper sulfate reference electrode (CSE) and the instant power-off potential method, the polarization potentials E1 and E2 of the pipeline at trenchless crossing are measured to be −1150 mV and −956 mV respectively;
6. Based on the length L (1000 m) of the pipeline at trenchless crossing and the resistivity ρ (7002 m) of the soil near the pipeline at trenchless crossing, by consulting the pipeline at trenchless crossing polarization potential threshold table and combining with Formula (3), the following equation is obtained:

(70−50)/(100−70)−(Eₘₐₓ−(−1100))/(−1170−Eₘₐₓ)
7. Through calculation, Eₘₐₓ=−1128 mV is obtained.
8. By comparing the values of E1, E2 and Eₘₐₓ respectively, it is found that E1=−1150 mV<Eₘₐₓ=−1128 mV, while E2=−956 mV>Eₘₐₓ=−1128 mV. It is considered that some pipe sections of the pipeline at trenchless crossing are not effectively protected, and the cathodic protection system needs to be optimized;
9. Since the pipeline at trenchless crossing adopts the impressed current cathodic protection, and the current operation mode of the impressed current cathodic protection system is the potentiostat mode with the set control potential of −1250 mV, the control potential is gradually set to be −1300 mV, −1350 mV, −1400 mV and −1450 mV. The instant power-off potential method is used in sequence to test the polarization potentials E1 and E2 at both ends of the pipeline at trenchless crossing. It is found that when the control potential is set to be −1450 mV, E1 and E2 are −1190 mV and −1130 mV respectively, both of which are smaller than Eₘₐₓ=−1128 mV. The cathodic protection potentials of all sections of the pipeline at trenchless crossing meet the standards and are effectively protected, thus completing the optimization of the cathodic protection effect.

Unless specifically stated otherwise, terms such as processing, computing, calculating, determining, displaying or the like may refer to actions and/or processes of one or more processing or computing systems, or similar devices, the actions and/or processes manipulate and transform data represented as physical, such as electronic, quantities within the processing system's registers or memories into other data similarly represented as physical quantities within the processing system's memories, registers or other such information storage, transmission or display devices. Information and signals may be represented using any of a variety of different technologies and methods. For example, data, instructions, commands, information, signals, bits, symbols, and chips that may be referenced throughout the above description may be represented by voltages, currents, electromagnetic waves, magnetic fields or particles, optical fields or particles, or any combination thereof.

It should be understood that the specific order or hierarchy of steps in the processes disclosed is an example of exemplary approaches. Based upon design preferences, it should be understood that the specific order or hierarchy of steps in the processes may be rearranged without departing from the scope of the present disclosure. The accompanying method claims present elements of the various steps in an exemplary order, and are not meant to be limited to the specific order or hierarchy presented.

In the foregoing detailed description, various features are grouped together in a single embodiment for the purpose of streamlining the disclosure. This method of disclosure is not to be interpreted as reflecting an intention that embodiments of the claimed subject matter require more features than those explicitly recited in each claim. Conversely, as reflected in the appended claims, the present disclosure exists in a state with fewer features than those of the disclosed individual embodiments. Therefore, the appended claims are hereby explicitly incorporated into the detailed description, with each claim independently serving as a separate preferred embodiment of the present disclosure.

Those skilled in the art will also appreciate that the various illustrative logical blocks, modules, circuits, and algorithmic steps described in connection with the embodiments herein can all be implemented as electronic hardware, computer software, or combinations thereof. In order to clearly illustrate the interchangeability between hardware and software, various illustrative components, blocks, modules, circuits, and steps have been generally described above with respect to their functions. Whether such function is implemented in hardware or software depends on the particular application and the design constraints imposed on the overall system. Those skilled may implement the described function in a variable manner for each particular application, however, such implementation decisions should not be construed as departing from the scope of the present disclosure.

The steps of a method or algorithm described in connection with the embodiments herein may be embodied directly in hardware, in a software module executed by a processor, or in a combination thereof. A software module may reside in a RAM memory, a flash memory, a ROM memory, an EPROM memory, an EEPROM memory, a register, a hard disk, a removable disk, a CD-ROM, or any other form of storage medium known in the art. An exemplary storage medium is coupled to the processor such that the processor can read information from, and write information to, the storage medium. Of course, the storage medium may be integral to the processor. The processor and the storage medium may reside in an ASIC. The ASIC may reside in a user terminal. Of course, the processor and the storage medium may reside as discrete components in a user terminal.

For a software implementation, the techniques described herein may be implemented with modules (e.g., procedures, functions, and so on) that perform the functions described herein. These software codes may be stored in a memory unit and executed by a processor. The memory unit may be implemented within the processor or external to the processor. In the latter case, it is communicatively coupled to the processor via various means, which is well-known in the art.

The foregoing description includes examples of one or more embodiments. It is, of course, not possible to describe all possible combinations of components or methods for purposes of describing the above-described embodiments, but those of ordinary skill in the art will recognize that further combinations and permutations of various embodiments are possible. Accordingly, the embodiments described herein are intended to embrace all such alterations, modifications and variances that fall within the scope of the appended claims. Furthermore, with respect to the term “comprising” as used in the specification or claims, its inclusive manner is analogous to the term “including” as explained when “including” serves as a transitional phrase in claims. Additionally, any use of the term “or” in the specification or claims is intended to denote “non-exclusive or”.

1. A method for determining the cathodic protection effectiveness of a pipeline at trenchless crossing, comprising:
obtaining construction parameters of a pipeline at trenchless crossing to be evaluated, according to the construction parameters, determining a soil resistivity corresponding to the pipeline at trenchless crossing to be evaluated, and corresponding polarization potentials at both ends;
from a preconstructed polarization potential threshold table of pipeline at trenchless crossing, obtaining a first polarization potential threshold corresponding to a length and the soil resistivity in the construction parameters, wherein the polarization potential threshold table comprises the length of the entire pipeline at trenchless crossing, the soil resistivity corresponding to the pipeline at trenchless crossing, and the first polarization potential threshold, and the polarization potential threshold table represents the corresponding relationship among the length, the soil resistivity, and the polarization potential threshold of the pipeline at trenchless crossing; and
according to the polarization potentials at both ends and first polarization potential threshold corresponding to the pipeline at trenchless crossing to be evaluated, determining the cathodic protection effectiveness of the pipeline at trenchless crossing to be evaluated.

2. The method according to claim 1, wherein determining the soil resistivity corresponding to the pipeline at trenchless crossing to be evaluated comprises:
adopting the following formula to determine a spacing between two adjacent probes during testing:
αᵢ=INT(h~H);
in the above formula, h represents the buried depth at both ends of the pipeline at trenchless crossing, H represents the maximum buried depth of the pipeline at trenchless crossing, and INT represents an integer function;
adopting the following formula to obtain the soil resistivity corresponding to the pipeline at trenchless crossing:
$$ρ = {max}_{h \leq i \leq H} ( 2 π {a}_{i} {R}_{i} ) ;$$
in the above formula, h represents the buried depth at both ends of the pipeline at trenchless crossing, H represents the maximum buried depth of the pipeline at trenchless crossing, aᵢ represents the spacing between two adjacent probes during testing, and Rᵢ represents a resistance value of the soil near the pipeline at trenchless crossing when the spacing between two adjacent probes is aᵢ.

3. The method according to claim 1, wherein, from the preconstructed polarization potential threshold table of pipeline at trenchless crossing, obtaining the first polarization potential threshold corresponding to the length and soil resistivity in the construction parameters further comprises:
if the soil resistivity corresponding to the pipeline at trenchless crossing to be evaluated is within a preset soil resistivity range, then according to the length of the pipeline at trenchless crossing to be evaluated and two end values of the preset soil resistivity range, matching a second polarization potential threshold and a third polarization potential threshold corresponding to the length of the pipeline at trenchless crossing to be evaluated and the two end values in the polarization potential threshold table of pipeline at trenchless crossing;
adopting the following formula to calculate the first polarization potential threshold corresponding to the pipeline at trenchless crossing to be evaluated:
(ρ−ρ₁)/(ρ₂−φ=(Eₘₐₓ−E₁)/(E₂−Eₘₐₓ);
in the above formula, Eₘₐₓ represents the first polarization potential threshold, ρ represents the soil resistivity corresponding to the pipeline at trenchless crossing, ρ₁ and ρ₂ represent the two end values of the preset soil resistivity range, E₁ represents the second polarization potential threshold, and E₂ represents the third polarization potential threshold;
if the soil resistivity corresponding to the pipeline at trenchless crossing to be evaluated is not within the preset soil resistivity range, then according to the length of the pipeline at trenchless crossing to be evaluated and the soil resistivity, matching a first polarization potential threshold corresponding to the length and the soil resistivity of the pipeline at trenchless crossing to be evaluated in the polarization potential threshold table of pipeline at trenchless crossing.

4. The method according to claim 1, wherein, according to the polarization potentials at both ends and the first polarization potential threshold corresponding to the pipeline at trenchless crossing to be evaluated, determining the cathodic protection effectiveness of the pipeline at trenchless crossing to be evaluated comprises:
judging whether the polarization potentials at both ends corresponding to the pipeline at trenchless crossing to be evaluated are both less than the first polarization potential threshold, if yes, determining that the cathodic protection for the pipeline at trenchless crossing to be evaluated is effective; if not, determining that the cathodic protection for the pipeline at trenchless crossing to be evaluated is ineffective.

5. A method for constructing a polarization potential threshold table of pipeline at trenchless crossing, comprising:
obtaining construction parameters and soil environment parameters of a pipeline at trenchless crossing;
calculating a soil resistivity corresponding to the pipeline at trenchless crossing according to the construction parameters;
according to the construction parameters and the soil environment parameters, adopting a method of numerical simulation to construct a threshold model of polarization potentials at both ends of the pipeline; calculating polarization potential thresholds corresponding to the pipeline at trenchless crossing under different types of external anti-corrosion coatings and different soil resistivities using the threshold model of polarization potentials at both ends of the pipeline; and
constructing the polarization potential threshold table of pipeline at trenchless crossing according to the length in the construction parameters of the entire pipeline at trenchless crossing, the soil resistivity corresponding to the pipeline at trenchless crossing, and the polarization potential threshold corresponding to the pipeline at trenchless crossing.

6. An apparatus for determining the cathodic protection effectiveness of a pipeline at trenchless crossing, comprising:
a first determining module, configured to obtain construction parameters of a pipeline at trenchless crossing to be evaluated, according to the construction parameters, determine a soil resistivity corresponding to the pipeline at trenchless crossing to be evaluated, and corresponding polarization potentials at both ends;
an obtaining module, configured to, from a preconstructed polarization potential threshold table of pipeline at trenchless crossing, obtain a first polarization potential threshold corresponding to a length and the soil resistivity in the construction parameters, wherein the polarization potential threshold table comprises the length of the entire pipeline at trenchless crossing, the soil resistivity corresponding to the pipeline at trenchless crossing, and the first polarization potential threshold, and the polarization potential threshold table represents the corresponding relationship among the length, the soil resistivity, and the polarization potential threshold of the pipeline at trenchless crossing; and
a second determining module, configured to, according to the polarization potentials at both ends and first polarization potential threshold corresponding to the pipeline at trenchless crossing to be evaluated, determine the cathodic protection effectiveness of the pipeline at trenchless crossing to be evaluated.

7-10. (canceled)

11. The apparatus according to claim 6, wherein determining the soil resistivity corresponding to the pipeline at trenchless crossing to be evaluated comprises:
adopting the following formula to determine a spacing between two adjacent probes during testing:
αᵢ=INT(h~H);
in the above formula, h represents the buried depth at both ends of the pipeline at trenchless crossing, H represents the maximum buried depth of the pipeline at trenchless crossing, and INT represents an integer function;
adopting the following formula to obtain the soil resistivity corresponding to the pipeline at trenchless crossing:
$$ρ = {max}_{h \leq i \leq H} ( 2 π {a}_{i} {R}_{i} ) ;$$
in the above formula, h represents the buried depth at both ends of the pipeline at trenchless crossing, H represents the maximum buried depth of the pipeline at trenchless crossing, aᵢ represents the spacing between two adjacent probes during testing, and Rᵢ represents a resistance value of the soil near the pipeline at trenchless crossing when the spacing between two adjacent probes is aᵢ.

12. The apparatus according to claim 6, wherein, from the preconstructed polarization potential threshold table of pipeline at trenchless crossing, obtaining the first polarization potential threshold corresponding to the length and soil resistivity in the construction parameters further comprises:
if the soil resistivity corresponding to the pipeline at trenchless crossing to be evaluated is within a preset soil resistivity range, then according to the length of the pipeline at trenchless crossing to be evaluated and two end values of the preset soil resistivity range, matching a second polarization potential threshold and a third polarization potential threshold corresponding to the length of the pipeline at trenchless crossing to be evaluated and the two end values in the polarization potential threshold table of pipeline at trenchless crossing;
adopting the following formula to calculate the first polarization potential threshold corresponding to the pipeline at trenchless crossing to be evaluated:
(ρ−ρ₁)/(ρ₂−ρ)=(Eₘₐₓ−E₁)/(E₂−Eₘₐₓ);
in the above formula, Eₘₐₓ represents the first polarization potential threshold, ρ represents the soil resistivity corresponding to the pipeline at trenchless crossing, ρ₁ and ρ₂ represent the two end values of the preset soil resistivity range, E₁ represents the second polarization potential threshold, and E₂ represents the third polarization potential threshold;
if the soil resistivity corresponding to the pipeline at trenchless crossing to be evaluated is not within the preset soil resistivity range, then according to the length of the pipeline at trenchless crossing to be evaluated and the soil resistivity, matching a first polarization potential threshold corresponding to the length and the soil resistivity of the pipeline at trenchless crossing to be evaluated in the polarization potential threshold table of pipeline at trenchless crossing.

13. The apparatus according to claim 6, wherein, according to the polarization potentials at both ends and the first polarization potential threshold corresponding to the pipeline at trenchless crossing to be evaluated, determining the cathodic protection effectiveness of the pipeline at trenchless crossing to be evaluated comprises:
judging whether the polarization potentials at both ends corresponding to the pipeline at trenchless crossing to be evaluated are both less than the first polarization potential threshold, if yes, determining that the cathodic protection for the pipeline at trenchless crossing to be evaluated is effective; if not, determining that the cathodic protection for the pipeline at trenchless crossing to be evaluated is ineffective.
